(19) United States
(12) Patent Application Publication
(10) Pub. No.: US 2007/0258344 A1
(43) Pub. Date: Nov. 8, 2007

(54) Simultaneously accessing multiple layers of optical disks

(75) Inventors: Daniel J. Rogers, Grant, MN (US); Jathan D. Edwards, Afton, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 11/418,584

(22) Filed: May 4, 2006

(51) Int. Cl. G11B 7/00

(52) U.S. Cl. 369/112.01; 369/94

(57) ABSTRACT

Techniques are described for simultaneously accessing multiple layers of an optical data storage medium using optical elements. The techniques include passing light through one or more optical elements included in an optical device to generate multiple light beams with focus points on two or more layers of a multi-layer optical disk. In some cases, the optical device may include a single optical element that generates multiple light beams. In other cases, the optical device may include two or more optical elements that each generates a single light beam. In either case, the optical device may simultaneously access two or more of the layers of the optical disk. An optical element may comprise a diffractive optical element or a holographic optical element designed to accommodate the separation distance between each of the layers of a multi-layer optical disk and a power ratio for the layers of the multi-layer optical disk.

### TECHNICAL FIELD

The invention relates to multi-layer optical data storage disks and, more particularly, techniques for accessing the multiple layers of multi-layer optical data storage disks.

### BACKGROUND

Optical data storage disks have gained widespread acceptance for the storage, distribution and retrieval of large volumes of information. Optical data storage disks include, for example, audio CD (compact disc), CD-R (CD-recordable), CD-RW (CD-rewritable) CD-ROM (CD-read only memory), DVD (digital versatile disk or digital video disk), DVD-RAM (DVD-random access memory), and various other types of writable or rewriteable media, such as magneto-optical (MO) disks, phase change optical disks, and others. Some newer formats for optical data storage disks are progressing toward smaller disk sizes and increased data storage density. For example, some new media formats boast finer track pitches and increased storage density using blue-violet wavelength lasers for data readout and/or data recording. Examples of blue disk media include Blu-Ray and HD-DVD.

Optical data storage disks are typically produced by first making a data storage disk master that has a surface pattern that represents encoded data on the master surface. The surface pattern, for instance, may be a collection of grooves or other features that define master pits and master lands, e.g., typically arranged in either a spiral or concentric manner. The master is typically not suitable as a mass replication surface with the master features defined within an etched photoresist layer formed over a master substrate.

After creating a suitable master, that master can be used to make a stamper, which is less fragile than the master. The stamper is typically formed of electroplated metal or a hard plastic material, and has a surface pattern that is the inverse of the surface pattern encoded on the master. An injection mold can use the stamper to fabricate large quantities of replica disks. Also, photopolymer replication processes, such as rolling bead processes, have been used to fabricate replica disks using stampers. In any case, each replica disk may contain the data and tracking information that was originally encoded on the master surface and preserved in the stamper. The replica disks can be coated with a reflective layer and/or a phase change layer, and are often sealed with an additional protective layer.

In some cases, optical data storage disks may comprise multi-layer optical disks that include two or more layers of data and tracking information. In order to access each of the layers of the multi-layer optical data storage disk, a conventional optical device must pass over the optical disk multiple times wherein the focus offset selects which layer is to be addressed. For example, the optical device must pass over a dual-layer optical data storage disk twice in order to sequentially focus a light beam of a suitable intensity onto each of the two layers.

### SUMMARY

In general, the invention is directed to techniques for simultaneously accessing multiple layers of an optical data storage medium using optical elements. In particular, the techniques include passing light through one or more optical elements included in an optical device to generate multiple light beams with focus points on two or more layers of a multi-layer optical disk. In other words, each of the multiple light beams generated by passing light through the one or more optical elements has a focus point on one of the multiple layers of the optical disk. In some cases the optical device may include a single optical element that generates multiple light beams by passing light through the optical element. In other cases, the optical device may include two or more optical elements that each generates a single light beam by passing light through the respective elements. In either case, the optical device may simultaneously access two or more of the layers of the optical disk in a single pass.

An optical element according to the invention may comprise a diffractive optical element (DOE) or a holographic optical element (HOE). In some cases, one or more optical elements may be positioned adjacent a refractive element, such as an objective lens, within an existing optical device. In other cases, one or more optical elements may be combined with a refractive lens to form a new optical device. The resulting optical device may be utilized within a phase change initialization system or as a read head within a disk drive.

An optical element, as described herein, may be designed to accommodate the separation distance between each of the layers of a multi-layer optical disk and a power ratio for the layers of the multi-layer optical disk. Most of the multi-layer optical data storage medium formats have uniform layer separation distances. However, some multi-layer optical data storage medium formats may have non-uniform layer separation distances. In some cases, the power levels may be substantially constant for each of the multiple layers of the optical disk. In other cases, the power levels may vary significantly for the multiple layers of the optical disk. In this way, the optical element may generate one or more light beams with focus points on each of the layers and with appropriate intensity levels such that the power delivered to each of the layers meets a predetermined level. The term “intensity” is defined herein to mean power per unit area of a beam of light.

In one embodiment, the invention is directed to a method comprising generating multiple light beams by passing light through one or more optical elements. The method also comprises simultaneously accessing two or more layers of an optical data storage disk with the multiple light beams, wherein each of the multiple light beams has a focus point on one of the two or more layers of the optical data storage disk.

In another embodiment, the invention is directed to a system comprising an optical data storage disk including two or more layers, and an optical device including one or more light sources and one or more optical elements. The light sources pass light through the optical elements to generate multiple light beams, wherein each of the multiple light beams has a focus point on one of the two or more layers of the optical data storage disk to simultaneously access the two or more layers of the optical data storage disk.

In a further embodiment, the invention is directed to a method comprising determining separation distances between two or more layers of an optical data storage disk, and determining power ratios for the two or more layers of the optical data storage disk. The method also comprises creating an optical element that generates one or more light beams from an initial light beam, wherein each of the one or more light beams has a focus point on one of the two or more layers of the optical data storage disk based on the layer separation distances and the power ratios.

The invention may be capable of providing one or more advantages. For example, the described techniques may substantially increase production process throughput for initialization of multi-layer rewritable optical disks by initializing the multiple layers simultaneously. In the case of a dual-layer optical disk, for example, the techniques may double the production process throughput. In the case of a four-layer optical disk, the techniques may quadruple the production process throughput. Similarly, the techniques may substantially increase readout data rate for a read head of a disk drive when reading data stored on a multi-layer optical disk by reading data from the multiple layers simultaneously.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example initialization system capable of simultaneously initializing multiple layers of a multi-layer optical disk in accordance with an embodiment of the invention.

FIG. 2 is a block diagram illustrating an optical device simultaneously accessing two layers of a dual-layer optical disk with a single optical element in accordance with an embodiment of the invention.

FIG. 3 is a block diagram illustrating an optical device simultaneously accessing two layers of a dual-layer optical disk with two optical elements in accordance with an embodiment of the invention.

FIGS. 4A and 4B illustrate embodiments of a diffractive optical element.

FIG. 5 is a block diagram illustrating an optical device simultaneously accessing four layers of a multi-layer optical disk with a single optical element in accordance with an embodiment of the invention.

FIGS. 6A-6C are plots illustrating intensity levels for layers of a multi-layer optical disk at distances along the focal axis from an optical device.

FIG. 7 is a flowchart illustrating an exemplary operation of creating an optical element.

FIG. 8 is a flowchart illustrating an exemplary operation of simultaneously accessing multiple layers of a multi-layer optical data storage disk with a single optical element.

FIG. 9 is a flowchart illustrating an exemplary operation of simultaneously accessing multiple layers of a multi-layer optical data storage disk with multiple optical elements.

### DETAILED DESCRIPTION

The invention is directed to techniques for simultaneously accessing multiple layers of an optical data storage medium using optical elements. In particular, the techniques include passing light through one or more optical elements included in an optical device to generate multiple light beams with focus points on each layer of a multi-layer optical disk. In other words, each of the multiple light beams generated by the one or more optical elements has a focus point on one of the layers of the optical disk. In some cases the optical device may include a single optical element that generates multiple light beams by passing light through the optical element. In other cases, the optical device may include two or more optical elements that each generates a single light beam by passing light through each of the optical elements. In either case, the optical device may simultaneously access two or more of the layers of the optical disk in a single pass.

An optical element may comprise a diffractive optical element (DOE) or a holographic optical element (HOE). In some cases, one or more optical elements may be positioned adjacent a refractive element, such as an objective lens, within an existing optical device. In other cases, one or more optical elements may be combined with a refractive lens to form a new optical device. For example, the optical device may be utilized within a phase change initialization system, or as a read head within a disk drive.

In the case of a phase change initialization system, the techniques described herein enable the optical device to simultaneously initialize phase change recording material applied over multiple layers included in a rewritable optical data storage disk for data recording. The optical device provides focus points of multiple light beams to simultaneously access the layers of the multi-layer optical disk and alter the phase change recording material on the layers. In the case of a read head, the techniques described herein enable the optical device to simultaneously readout data stored on each layer of a multi-layer optical data storage disk. The optical device provides focus points of multiple light beams to simultaneously access the layers of the multi-layer optical disk and the layers, in turn, simultaneously reflect the multiple light beams back to the read head for readout of the layers. In either case, the optical device sweeps over the optical disk only once while providing focus points of multiple light beams generated by at least one optical element on two or more layers of the optical disk.

An optical element, as described herein, may be designed to accommodate the separation distance between each of the layers of a multi-layer optical disk and a power ratio for the layers of the multi-layer optical disk. Most standard multi-layer optical data storage medium formats have uniform layer separation distances. However, some multi-layer optical data storage medium formats may have non-uniform layer separation distances. For example, a dual-layer Blu-Ray optical disk has a layer separation of approximately 25 μm, and a dual-layer DVD or HD-DVD has a layer separation of approximately 55 μm. In this way, the optical element may generate one or more light beams with focus points on each of the layers. In other cases, a multi-layer optical data storage medium format may have non-uniform layer separation. For example, a four-layer optical disk may have separation distances of 10, 25 and 35 μm respectively between each of the successive layers.

Each of the layers of the optical disk defines a minimum intensity level required to access, e.g., initialize or read, the layer. The term “intensity” is defined herein to mean power per unit area of a beam of light. In some cases, each of the layers may require substantially equivalent intensity levels. In other cases, each of the layers may require a different intensity level. The power ratio for the layers of the multi-layer optical disk may be determined based on the intensity level for each of the multiple layers. In the case of a lower layer of the optical data storage disk, an intensity level may be determined for the lower layer and for transmission through one or more upper layers of the optical data storage disk. In this way, the optical element may generate one or more light beams with appropriate intensity levels such that the power delivered to each of the layers meets a predetermined level.

As discussed above, the techniques described herein may also be applied to a variety of optical devices for optical disks with any number of layers. For example, the optical devices may be utilized within phase change initialization systems, or as read heads within disk drives. In addition, the optical disks may include two or four layers, or any other number of layers. For purposes of illustration, the techniques will be described below in reference to optical devices within initialization systems. In addition, the techniques will be applied to optical disks with either two or four layers. However, the invention should not be limited in these respects.

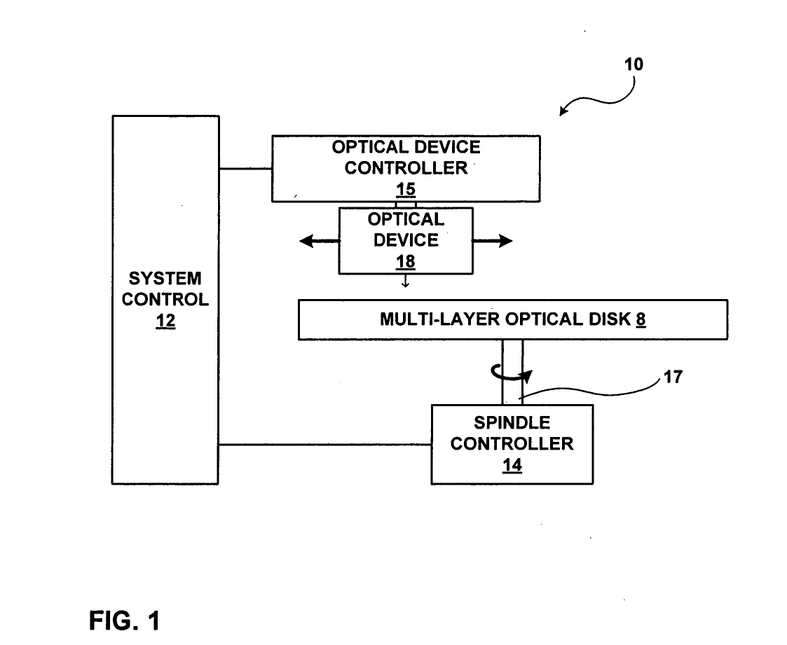

FIG. 1 is a block diagram illustrating an example initialization system 10 capable of simultaneously initializing multiple layers of a multi-layer optical disk 8 in accordance with an embodiment of the invention. In general, initialization system 10 includes a system control 12, an optical device controller 15, an optical device 18, a spindle 17, and a spindle controller 14. System control 12 may comprise a personal computer, a workstation, or other computer system. For example, system control 12 may comprise one or more processors that execute software to provide user control over system 10. System control 12 provides commands to spindle controller 14 and optical device controller 15 to define the operation of system 10 during the initialization process.

Multi-layer optical disk 8 may comprise a rewritable optical disk with two or more layers of data and tracking information. For example, multi-layer optical disk 8 may comprise a dual-layer optical disk with two information layers. In other cases, multi-layer optical disk 8 may comprise any number of information layers. The layers of multi-layer optical disk 8 may comprise disk-shaped polycarbonate substrates coated with a multi-layered thin-film stack including a phase change recording material. Other substrate materials of suitable optical surface quality may also be used for the two or more layers included in multi-layer optical disk 8. In addition, multi-layer optical disk 8 may include spacer material between each of the layers. Multi-layer optical disk 8 is carefully placed in system 10 on spindle 17.

In accordance with embodiments of the invention, optical device 18 includes one or more light sources and one or more optical elements. Each of the one or more optical elements may comprise a DOE or a HOE. The one or more optical elements generate multiple light beams with focus points on the two or more layers of multi-layer optical disk 8 to simultaneously initialize the layers. The multiple light beams simultaneously alter the phase change recording material coating the two or more layers of optical disk 8 according to commands by system control 12 to initialize the two or more layers for data recording. In this way, optical device 18 sweeps over multi-layer optical disk 8 only once while providing focus points of the multiple light beams generated by the at least one optical element on the two or more layers of multi-layer optical disk 8.

Spindle controller 14 causes spindle 17 to spin multi-layer optical disk 8, while optical device controller 15 controls the positioning of optical device 18 relative to optical disk 8. Optical device controller 15 also controls any on-off switching of light that is emitted from optical device 18. As multi-layer optical disk 8 spins on spindle 17, optical device controller 15 translates optical device 18 to desired positions and causes optical device 18 to emit the multiple light beams to simultaneously initialize the two or more layers of multi-layer optical disk 8.

The described techniques may substantially increase production process throughput for initialization of multi-layer rewritable optical disk 8 by initializing the multiple layers simultaneously. As an example, in the case of a dual-layer optical disk, the techniques may double the production process throughput.

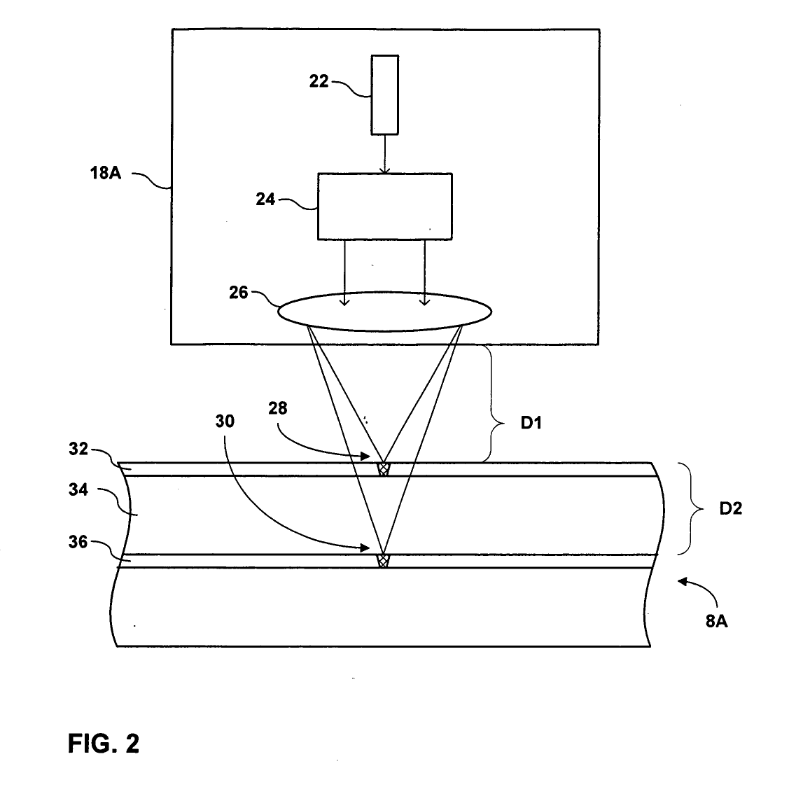

FIG. 2 is a block diagram illustrating an optical device 18A simultaneously accessing two layers of a dual-layer optical disk 8A with a single optical element 24 in accordance with an embodiment of the invention. Optical device 18A may correspond to optical device 18 in FIG. 1. Optical device 18A includes a light source 22, optical element 24, and a refractive lens 26. Also depicted in FIG. 2 is a portion of dual-layer optical disk 8A comprising a first layer 32 and a second layer 36. Optical device 18A generates two light beams from single optical element 24 and provides a focus point of each of the two light beams on one of the layers of dual-layer optical disk 8A to simultaneously initialize first layer 32 and second layer 36 of dual-layer optical disk 8A.

In the illustrated embodiment, dual-layer optical disk 8A comprises a rewritable dual-layer optical disk. Therefore, first layer 32 and second layer 36 of dual-layer optical disk 8A are coated with a multi-layer thin-film stack including a phase change recording material that must be initialized for data recording. Dual-layer optical disk 8A also includes a spacer material 34 between first layer 32 and second layer 36. As shown in FIG. 2, first layer 32 of dual-layer optical disk 8A is located a distance D1 along the focal axis from optical device 18A. Second layer 36 has a separation distance D2 from first layer 32. Most standard multi-layer optical data storage medium formats have a uniform layer separation distance. However, some multi-layer optical data storage medium formats may have non-uniform layer separation distances. In the case where dual-layer optical disk 8A comprises a dual-layer Blu-Ray optical disk, separation distance D2 between first layer 32 and second layer 36 may be approximately 25 μm. In the case where dual-layer optical disk 8A comprises a dual-layer DVD or HD-DVD, separation distance D2 between first layer 32 and second layer 36 may be approximately 55 μm. In other cases, a multi-layer optical data storage medium format may have non-uniform layer separation.

In addition, each of first layer 32 and second layer 36 of dual-layer optical disk 8A defines a minimum intensity level required to access, e.g., initialize, the layer. In other words, each of the layers 32 and 36 require a specific amount of power to alter the phase change recording material applied over the layers 32 and 36 and initialize the layers 32 and 36. In some cases, each of layers 32 and 36 may require a substantially equivalent intensity level. In other cases, each of layers 32 and 36 may require different intensity levels.

Within optical device 18A, optical element 24 is positioned adjacent refractive lens 26. In some cases, optical device 18A may comprise an existing optical device and optical element 24 may be positioned adjacent refractive lens 26 within the existing optical device. In other cases, optical device 18A may comprise a new optical device and optical element 24 may be combined with refractive lens 26 to form the new optical device.

Light source 22 passes an initial light beam through optical element 24. For example, light source 22 may pass a laser light beam with a wavelength of approximately 810 nm for initialization. In the illustrated embodiment, optical element 24 splits the initial light beam into two light beams. Refractive lens 26 then provides a first focus point 28 of the first light beam on first layer 32 of dual-layer optical disk 8A and provides a second focus point 30 of the second light beam on second layer 36 of dual-layer optical disk 8A. The two light beams have focus points 28 and 30 at specific distances along the focal axis between optical device 18A and dual-layer optical disk 8A to access layers 32 and 36, respectively. The two light beams also have a power ratio such that focus points 28 and 30 deliver appropriate intensity levels to layers 32 and 36 to meet the predetermined levels required by the layers 32 and 36.

Optical element 24 may comprise a DOE or a HOE designed based on separation distance D2 between first layer 32 and second layer 36 of dual-layer optical disk 8A and the power ratio for layers 32 and 36. In the case of a DOE, optical element 24 may include a surface relief pattern with a step grating, a blaze grating, or another type of grating. In this way, optical element 24 may generate two light beams with focus points 28 and 30 at appropriate locations and with appropriate intensity levels for the respective layers 32 and 36 of dual-layer optical disk 8A.

As shown in FIG. 2, optical device 18A provides first focus point 28 on first layer 32 located a distance D1 along the focal axis from optical device 18A. Optical device 18A also provides second focus point 30 on second layer 36 located a distance D2 from first layer 32. The power ratio for layers 32 and 36 of dual-layer optical disk 8A may be determined based on the intensity level for each of the two layers 32 and 36. In the case of second layer 36, an intensity level may be determined for second layer 36 and for transmission through first layer 32 and spacer material 34 of dual-layer optical disk 8A.

For example, first layer 32 may have an intensity level requirement of approximately 1 MW/cm² and second layer 32 may have an intensity level requirement of approximately 1.7 MW/cm². Therefore, the first light beam with first focus point 28 may have an intensity level of 1 MW/cm² to deliver to first layer 32. However, the second light beam with second focus point 30 on second layer 36 may have a total intensity level of between approximately 2 and 3 MW/cm². In this way, the second light beam may lose a portion of the total power for transmission through first layer 32 and spacer material 34 of dual-layer optical disk 8A and still deliver an intensity level of 1.7 MW/cm² to second layer 36.

Optical device 18A sweeps over dual-layer optical disk 8A only once while providing focus points 28 and 30 of the two light beams generated by optical element 24 on each of layers 32 and 36 of dual-layer optical disk 8A. In this way, optical device 18A may simultaneously initialize first layer 32 and second layer 36 by initializing the phase change recording material coated on the layers with focus points 28 and 30 of the light beams.

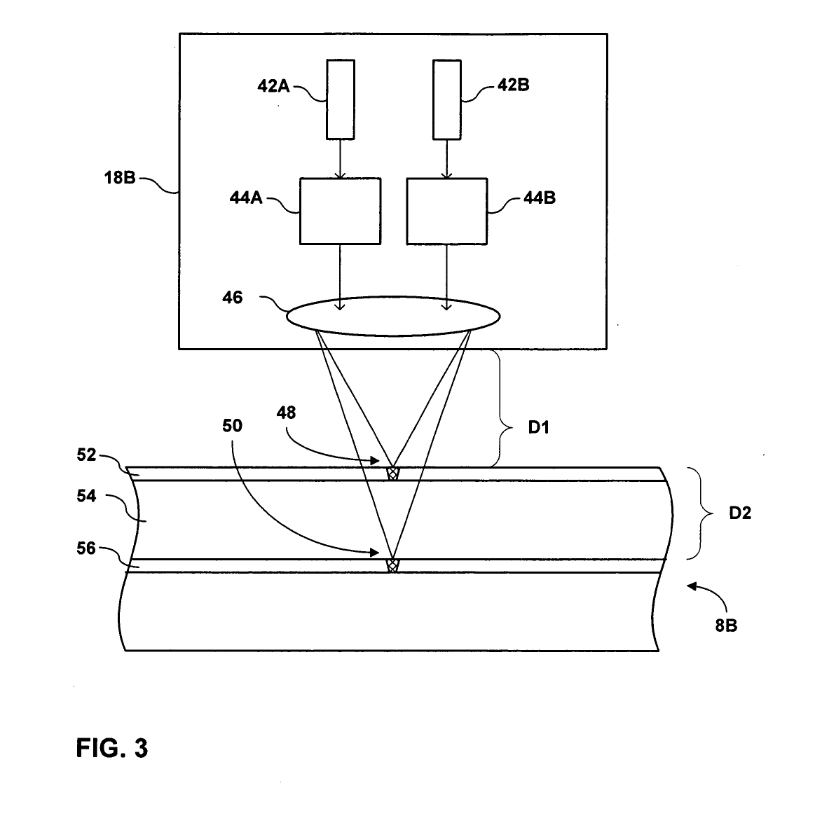

FIG. 3 is a block diagram illustrating an optical device 18B simultaneously accessing two layers of a dual-layer optical disk 8B with two optical elements 44A and 44B in accordance with an embodiment of the invention. Optical device 18B may correspond to optical device 18 in FIG. 1. Optical device 18B includes a first light source 42A, a second light source 42B, first optical element 44A, second optical element 44B, and a refractive lens 46. Also depicted in FIG. 3 is a portion of dual-layer optical disk 8B comprising a first layer 52 and a second layer 56. Optical device 18B generates two light beams from first optical element 44A and second optical element 44B and provides a focus point of each of the two light beams on one of the layers of dual-layer optical disk 8B to simultaneously initialize first layer 52 and second layer 56 of dual-layer optical disk 8B.

In the illustrated embodiment, dual-layer optical disk 8B comprises a rewritable dual-layer optical disk. Therefore, first layer 52 and second layer 56 of dual-layer optical disk 8B are coated with a multi-layer thin-film stack including a phase change recording material that must be initialized for data recording. Dual-layer optical disk 8B also includes spacer material 54 between first layer 52 and second layer 56. As shown in FIG. 3, first layer 52 of dual-layer optical disk 8B is located a distance D1 along the focal axis from optical device 18B. Second layer 56 has a separation distance D2 from first layer 52. As described above, most standard multi-layer optical data storage medium formats have a uniform layer separation distance.

In addition, each of first layer 52 and second layer 56 of dual-layer optical disk 8B defines a minimum intensity level required to access, e.g., initialize, the layer. In other words, each of the layers 52 and 56 require a specific amount of power to alter the phase change recording material applied over the layers 52 and 56 and initialize the layers 52 and 56. In some cases, each of layers 52 and 56 may require a substantially equivalent intensity level. In other cases, each of layers 52 and 56 may require different intensity levels.

Within optical device 18B, optical elements 44A and 44B are positioned adjacent refractive lens 46. In other embodiments, first optical element 44A may be positioned adjacent a first refractive lens within optical device 18B and second optical element 44B may be positioned adjacent a second refractive lens within optical device 18B. In some cases, optical device 18B may comprise an existing optical device, and first optical element 44A and second optical element 44B may be positioned adjacent refractive lens 46 within the existing optical device. In other cases, optical device 18B may comprise a new optical device, and first optical element 44A and second optical element 44B may be combined with refractive lens 46 to form the new optical device.

First light source 42A passes an initial light beam through first optical element 44A and second light source 42B passes an initial light beam through second optical element 44B. For example, light sources 42A and 42B may pass laser light beams with wavelengths of approximately 810 nm for initialization. In the illustrated embodiment, first optical element 44A generates a first light beam and second optical element 44B generates a second light beam. Refractive lens 46 then provides a first focus point 48 of the first light beam on first layer 52 of multi-layer optical disk 8B and provides a second focus point 50 of the second light beam on second layer 56 of multi-layer optical disk 8B. The two light beams have focus points 48 and 50 at specific distances along the focal axis between optical device 18B and dual-layer optical disk 8B to access layers 52 and 56, respectively. The two light beams also have a power ratio such that focus points 48 and 50 deliver appropriate intensity levels to layers 52 and 56 to meet the predetermined levels required by the layers 52 and 56.

First optical element 44A may comprise a DOE or a HOE designed based on distance D1 between optical device 18B and first layer 52 of dual-layer optical disk 8B and the intensity level for first layer 52. Second optical element 44B may comprise a DOE or a HOE designed based on separation distance D2 between first layer 52 and second layer 56 of dual-layer optical disk 8A and the intensity level for second layer 56. In the case of DOEs, each of optical elements 44A and 44B may include a surface relief pattern with a step grating, a blaze grating, or another type of grating. In this way, each of optical elements 44A and 44B may generate a single light beam with focus point 48 or 50 at an appropriate location and with an appropriate intensity level for the respective one of layers 52 and 56 of dual-layer optical disk 8B.

As shown in FIG. 3, optical device 18B provides first focus point 48 on first layer 52 located a distance D1 along the focal axis from optical device 18B. Optical device 18B also provides second focus point 50 on second layer 56 located a distance D2 from first layer 52. The power ratio for layers 52 and 56 of dual-layer optical disk 8B may be determined based on the intensity level for each of the two layers 52 and 56. In the case of second layer 56, an intensity level may be determined for second layer 56 and for transmission through first layer 52 and spacer material 54 of dual-layer optical disk 8B.

Optical device 18B sweeps over dual-layer optical disk 8B only once while providing focus points 48 and 50 of the two light beams generated by optical elements 44A and 44B on each of layers 52 and 56 of dual-layer optical disk 8B. In this way, optical device 18B may simultaneously initialize first layer 52 and second layer 56 by altering the phase change recording material coated on the layers with focus points 48 and 50 of the light beams.

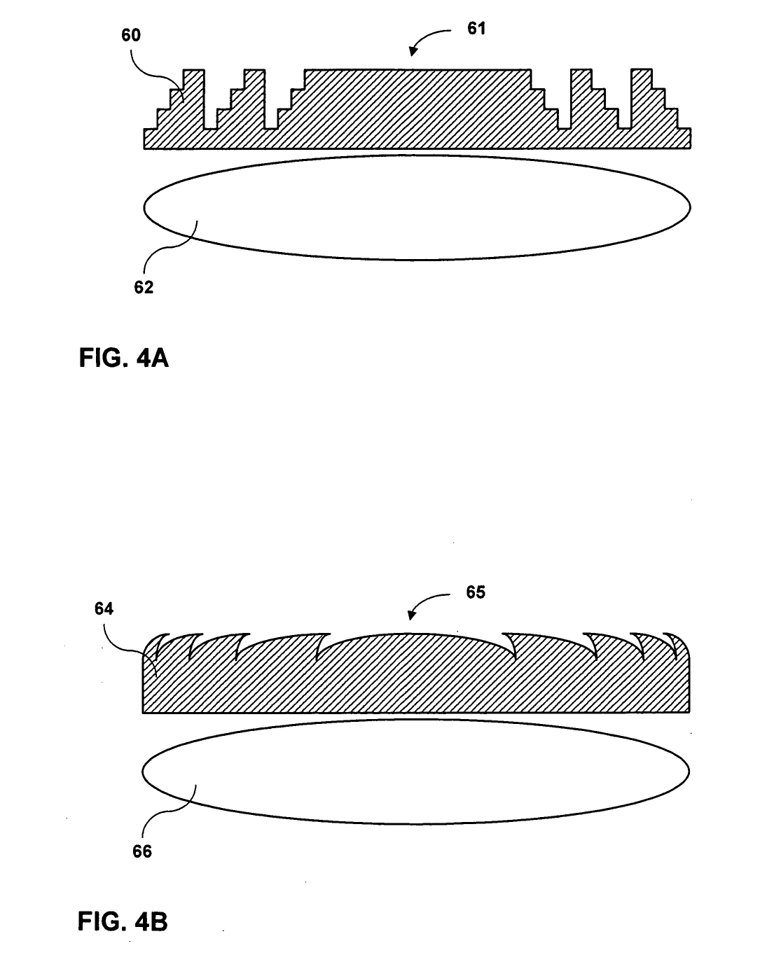

FIGS. 4A and 4B illustrate embodiments of a diffractive optical element. FIG. 4A illustrates a DOE 60 that includes a surface relief pattern with a step grating 61 designed to generate one or more light beams from an initial light beam. Step grating 61 may comprise a series of substantially rectangular shaped grooves on the surface of DOE 60. The number of steps, depth of the steps, and distance between the steps of step grating 61 may determine the number of light beams generated from the initial light beam by DOE 60. DOE 60 may be positioned adjacent a refractive lens 62 within an optical device. In some cases, DOE 60 may be positioned adjacent refractive lens 62 within an existing optical device. In other cases, DOE 60 may be combined with refractive lens 62 to form a new optical device. DOE 60 may correspond to any of optical element 24 from FIG. 2 or optical elements 44A and 44B from FIG. 3.

FIG. 4B illustrates a DOE 64 that includes a surface relief pattern with a blaze grating 65 designed to generate one or more light beams from an initial light beam. Blaze grating 65 may comprise a series of substantially triangular shaped grooves on the surface of DOE 64. The number of blazes, depth of the blazes, and distance between the blazes of blaze grating 65 may determine the number of light beams generated from the initial light beam by DOE 64. DOE 64 may be positioned adjacent a refractive lens 66 within an optical device. In some cases, DOE 64 may be positioned adjacent refractive lens 66 within an existing optical device. In other cases, DOE 64 may be combined with refractive lens 66 to form a new optical device. DOE 64 may correspond to any of optical element 24 from FIG. 2 or optical elements 44A and 44B from FIG. 3.

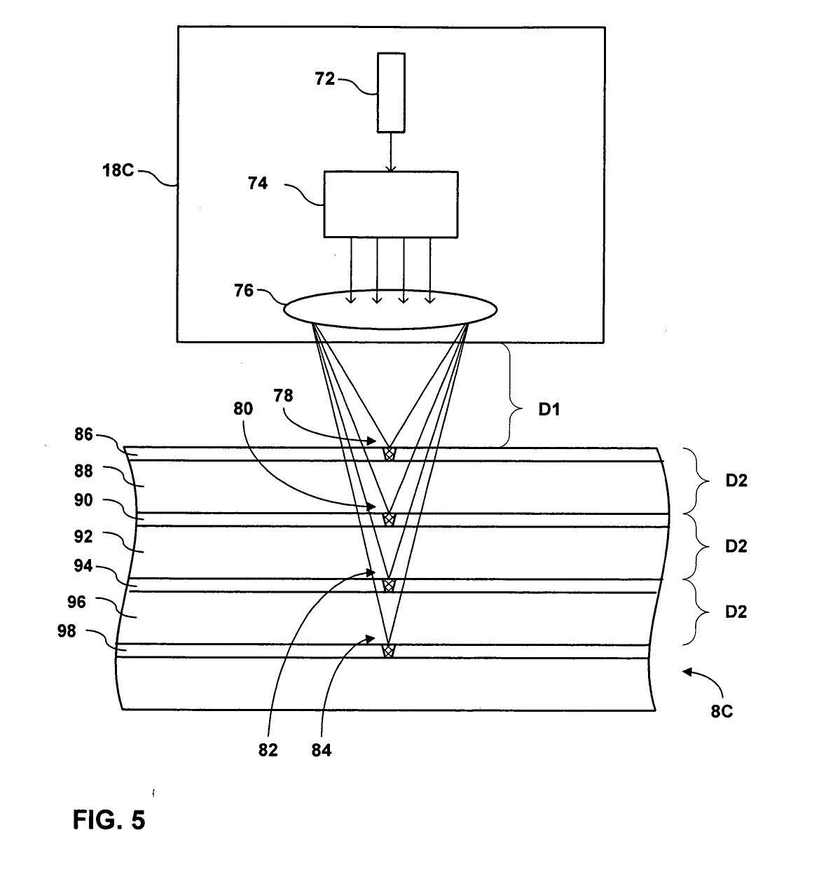

FIG. 5 is a block diagram illustrating an optical device 18C simultaneously accessing four layers of a multi-layer optical disk 8C with a single optical element 74 in accordance with an embodiment of the invention. Optical device 18C may correspond to optical device 18 in FIG. 1. Optical device 18C includes a light source 72, optical element 74, and a refractive lens 76. Also depicted in FIG. 5 is a portion of multi-layer optical disk 8C comprising a first layer 86, a second layer 90, a third layer 94, and a fourth layer 98. Optical device 18C generates four light beams from single optical element 74 and provides a focus point of each of the four light beams on one of the layer of multi-layer optical disk 8C to simultaneously initialize first layer 86, second layer 90, third layer 94, and fourth layer 98 of multi-layer optical disk 8C.

In the illustrated embodiment, multi-layer optical disk 8C comprises a rewritable multi-layer optical disk. Therefore, first layer 86, second layer 90, third layer 94, and fourth layer 98 of dual-layer optical disk 8C are coated with a multi-layer thin-film stack including a phase change recording material that must be initialized for data recording. Multi-layer optical disk 8C also includes spacer material 88 between first layer 86 and second layer 90, spacer material 92 between second layer 90 and third layer 94, and spacer material 96 between third layer 94 and fourth layer 98.

As shown in FIG. 5, first layer 86 of multi-layer optical disk 8C is located a distance D1 along the focal axis from optical device 18C. Second layer 90 has a separation distance D2 from first layer 86, third layer 94 has separation distance D2 from second layer 90, and fourth layer 98 has separation distance D2 from fourth layer 98. Most standard multi-layer optical data storage medium formats have a uniform layer separation distance. However, some multi-layer optical data storage medium formats may have non-uniform layer separation distances. In the case where multi-layer optical disk 8C comprises a multi-layer Blu-Ray optical disk, separation distance D2 between each of layers 86, 90, 94, and 98 may be approximately 25 μm. In the case where multi-layer optical disk 8C comprises a multi-layer DVD or HD-DVD, separation distance D2 between each of layers 86, 90, 94, and 98 may be approximately 55 μm. In other cases, a multi-layer optical data storage medium format may have non-uniform layer separation. For example, a four-layer optical disk may have separation distances of 10, 25 and 35 μm respectively between each of the successive layers.

In addition, each of first layer 86, second layer 90, third layer 94, and fourth layer 98 of multi-layer optical disk 8C defines a minimum intensity level required to access, e.g., initialize, the layer. In other words, each of layers 86, 90, 94, and 98 require a specific amount of power to alter the phase change recording material applied over the layers and initialize the layers. In some cases, each of layers 86, 90, 94, and 98 may require a substantially equivalent intensity level. In other cases, each of layers 86, 90, 94, and 98 may require a different intensity level.

Within optical device 18C, optical element 74 is positioned adjacent refractive lens 76. In some cases, optical device 18C may comprise an existing optical device and optical element 74 may be positioned adjacent refractive lens 76 within the existing optical device. In other cases, optical device 18C may comprise a new optical device and optical element 74 may be combined with refractive lens 76 to form the new optical device.

Light source 72 passes an initial light beam through optical element 74. For example, light source 72 may pass a laser light beam with a wavelength of approximately 810 nm for initialization. In the illustrated embodiment, optical element 74 splits the initial light beam into four light beams. Refractive lens 76 then provides a first focus point 78 of the first light beam on first layer 86, provides a second focus point 80 of the second light beam on second layer 90, provides a third focus point 82 of the third light beam on third layer 94, and provides a fourth focus point 84 of the fourth light beam on fourth layer 98. The four light beams have focus points 78, 80, 82, and 84 at specific distances along the focal axis between optical device 18C and multi-layer optical disk 8C to access layers 86, 90, 94, and 98, respectively. The four light beams also have a power ratio such that focus points 78, 80, 82, and 84 deliver appropriate intensity levels to layers 86, 90, 94, and 98 to meet the predetermined levels required by the layers.

Optical element 74 may comprise a DOE or a HOE designed based on separation distance D2 between each of layers 86, 90, 94, and 98 of multi-layer optical disk 8C and the power ratio of layers 86, 90, 94, and 98. In the case of a DOE, optical element 74 may include a surface relief pattern with a step grating, a blaze grating, or another type of grating. In this way, optical element 74 may generate four light beams with focus points 78, 80, 82, and 84 at appropriate locations and with appropriate intensity levels for the respective layers 86, 90, 94, and 98 of multi-layer optical disk 8C.

As shown in FIG. 5, optical device 18C provides first focus point 78 on first layer 86 located a distance D1 along the focal axis from optical device 18C. Optical device 18C also provides second focus point 80 on second layer 90 located a distance D2 from first layer 86. Optical device 18C provides third focus point 82 on third layer 94 located a distance D2 from second layer 90. Finally, optical device 18C provides fourth focus point 84 on fourth layer 98 located a distance D2 from third layer 94.

The power ratio for layers 86, 90, 94, and 98 of multi-layer optical disk 8C may be determined based on the intensity level for each of the four layers. In the case of second layer 90, an intensity level may be determined for second layer 90 and for transmission through first layer 86 and spacer material 88 of multi-layer optical disk 8C. In the case of third layer 94, an intensity level may be determined for third layer 94 and for transmission through first layer 86, spacer material 88, second layer 90, and spacer material 92 of multi-layer optical disk 8C. In the case of fourth layer 98, an intensity level may be determined for fourth layer 98 and for transmission through first layer 86, spacer material 88, second layer 90, spacer material 92, third layer 94, and spacer material 96 of multi-layer optical disk 8C.

Optical device 18C sweeps over multi-layer optical disk 8C only once while providing focus points 78, 80, 82, and 84 of the four light beams generated by optical element 74 on each of layers 86, 90, 94, and 98 of dual-layer optical disk 8C. In this way, optical device 18C may simultaneously initialize first layer 86, second layer 90, third layer 94, and fourth layer 98 by altering the phase change recording material coated on the layers with focus points 78, 80, 82, and 84 of the light beams.

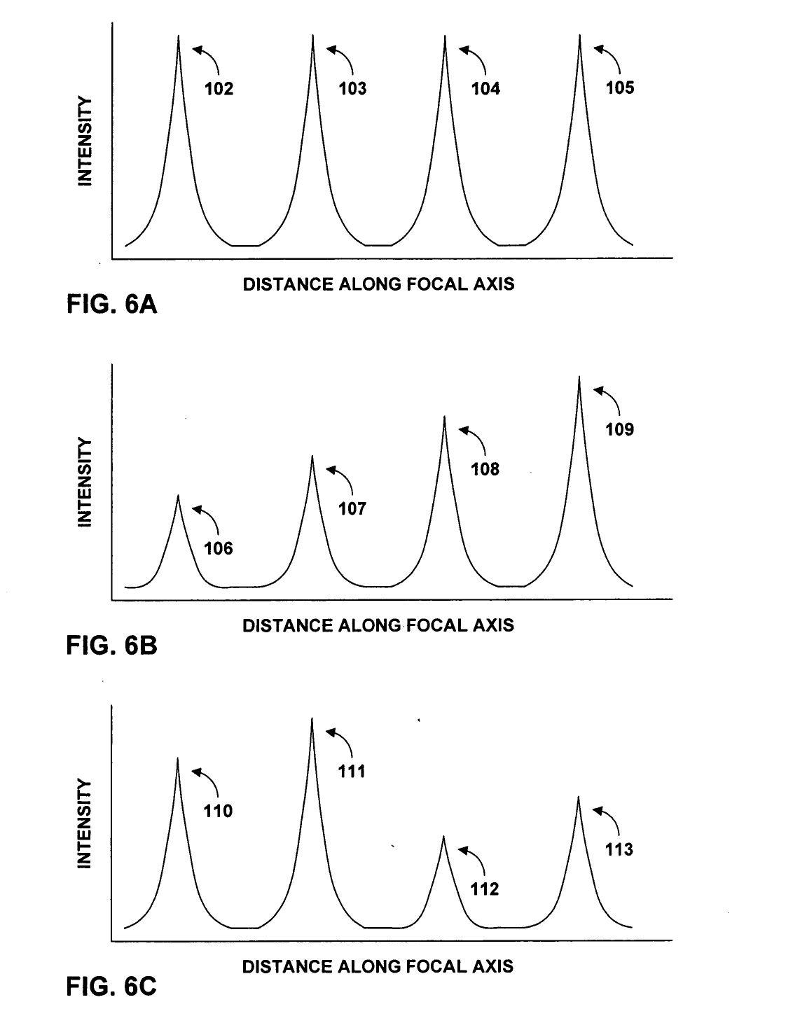

FIGS. 6A-6C are plots illustrating intensity levels for layers of multi-layer optical disk 8C at distances along the focal axis from optical device 18C. As illustrated in FIG. 5, multi-layer optical disk 8C includes four layers 86, 90, 94, and 98. As described above, each of the layers defines a minimum power intensity level required to access, e.g., initialize, the layer. Therefore, optical element 74 is designed to generate four light beams with focus points at specific distances from optical device 18C and with specific intensity levels for the layers of optical disk 8C.

FIG. 6A illustrates a first intensity peak 102 of focus point 78 of a first light beam from optical element 74, a second intensity peak 103 of focus point 80 of a second light beam from optical element 74, a third intensity peak 104 of focus point 82 of a third light beam from optical element 74, and a fourth intensity peak 105 of a focus point 84 of a fourth light beam from optical element 74. First intensity peak 102 is located a distance D1 along the focal axis from optical device 18C. Intensity peaks 103, 104, and 105 are each located a uniform distance D2 from the preceding layer of multi-layer optical disk 8C. In the illustrated embodiment, intensity peaks 102, 103, 104, and 105 are substantially equivalent and comprise an equivalent power ratio across layers 86, 90, 94, and 98 of multi-layer optical disk 8C.

FIG. 6B illustrates a first intensity peak 106 of focus point 78 of a first light beam from optical element 74, a second intensity peak 107 of focus point 80 of a second light beam from optical element 74, a third intensity peak 108 of focus point 82 of a third light beam from optical element 74, and a fourth intensity peak 109 of a focus point 84 of a fourth light beam from optical element 74. First intensity peak 106 is located a distance D1 along the focal axis from optical device 18C. Intensity peaks 107, 108, and 109 are each located a uniform distance D2 from the preceding layer of multi-layer optical disk 8C. In the illustrated embodiment, intensity peaks 106, 107, 108, and 109 are substantially different and comprise a ramping power ratio across layers 86, 90, 94, and 98 of multi-layer optical disk 8C.

FIG. 6C illustrates a first intensity peak 110 of focus point 78 of a first light beam from optical element 74, a second intensity peak 111 of focus point 80 of a second light beam from optical element 74, a third intensity peak 112 of focus point 82 of a third light beam from optical element 74, and a fourth intensity peak 113 of a focus point 84 of a fourth light beam from optical element 74. First intensity peak 110 is located a distance D1 along the focal axis from optical device 18C. Intensity peaks 111, 112, and 113 are each located a uniform distance D2 from the preceding layer of multi-layer optical disk 8C. In the illustrated embodiment, intensity peaks 110, 111, 112, and 113 are substantially different and comprise a random power ratio across layers 86, 90, 94, and 98 of multi-layer optical disk 8C. In other embodiments, the four light beams generated by optical element 74 may comprise another power ratio across the layers of multi-layer optical disk 8C.

In each of the illustrated embodiments, the second intensity level of focus point 80 on second layer 90 of optical disk 8C may include the intensity level required by second layer 90 and the intensity level required for transmission through first layer 86 and spacer 88 of optical disk 8C. The third intensity level of focus point 82 on third layer 94 of optical disk 8C may include the intensity level required by third layer 94 and the intensity level required for transmission through first layer 86, spacer 88, second layer 90, and spacer 92 of optical disk 8C. The fourth intensity level of focus point 84 on fourth layer 98 of optical disk 8C may include the intensity level required by fourth layer 94 and the intensity level required for transmission through first layer 86, spacer 88, second layer 90, spacer 92, third layer 94, and spacer 96 of optical disk 8C.

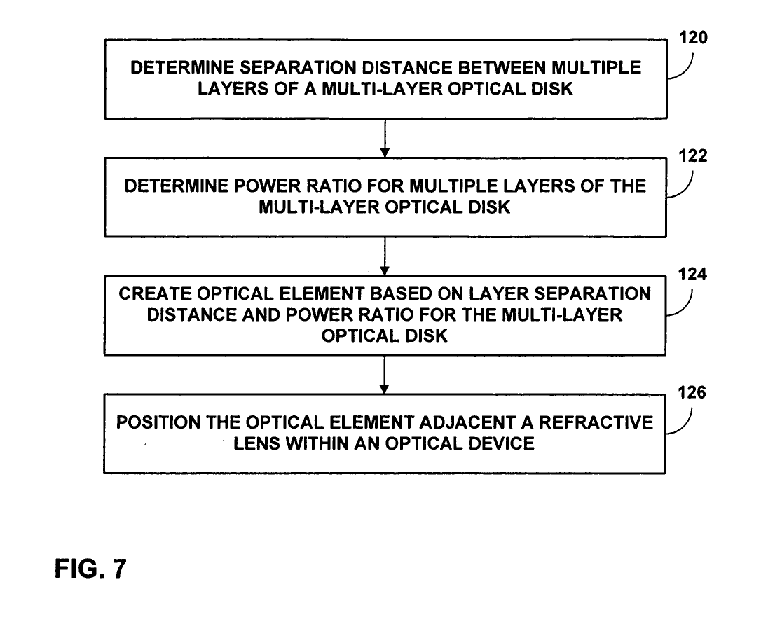

FIG. 7 is a flowchart illustrating an exemplary operation of creating an optical element. The operation will be described herein in reference to optical device 18A and dual-layer optical disk 8A from FIG. 2. In other embodiments, the operation may be applied to each of optical devices 44A and 44B and dual-layer optical disk 8B from FIG. 3 or to optical device 74 and multi-layer optical disk 8C from FIG. 5.

First, a separation distance, D2, between first layer 32 and second layer 36 of dual-layer optical disk 8A is determined (120). Most standard multi-layer optical data storage medium formats have a uniform layer separation distance. However, some multi-layer optical data storage medium formats may have non-uniform layer separation distances. In the case where optical disk 8A comprises a dual-layer Blu-Ray optical disk, separation distance D2 may be approximately 25 μm. In the case where optical disk 8A comprises a dual-layer DVD or HD-DVD optical disk, separation distance D2 may be approximately 55 μm. In other cases, a multi-layer optical data storage medium format may have non-uniform layer separation. For example, a four-layer optical disk may have separation distances of 10, and 35 μm respectively between each of the successive layers.

Then a power ratio for first layer 32 and second layer 36 of dual-layer optical disk 8A is determined (122). Each of the layers of the optical disk defines a minimum intensity level required to initialize the layer, i.e., alter the phase change recording material coating the layer. In some cases, first layer 32 and second layer 36 may require substantially equivalent intensity levels. In other cases, first layer 32 may require a first intensity level that is higher or lower than a second intensity level required by second layer 36. For example, when determining the intensity level for second layer 36, an intensity level may be determined for second layer 36 and for transmission through first layer 32 and spacer material 34 of dual-layer optical data storage disk 8A.

Optical element 24 may then be created based on the determined layer separation distance and the determined power ratio for dual-layer optical disk 8A (124). In this way, optical element 24 may generate two light beams with focus points on each of first layer 32 and second layer 36. Optical element 24 may comprise a DOE or a HOE. For example, optical element 24 may comprise a DOE including a surface relief pattern with a step grating designed to generate two light beams from an initial light beam, substantially similar to DOE 60 from FIG. 4A. As another example, optical element 24 may comprise a DOE including a surface relief pattern with a blaze grating designed to generate two light beams from an initial light beam, substantially similar to DOE 64 from FIG. 4B. In addition, optical element 24 may generate two light beams with appropriate intensity levels such that the power delivered to each of first layer 32 and second layer 36 meets a predetermined level.

Optical element 24 may be positioned adjacent refractive lens 26 within optical device 18A (126). In some cases, optical device 18A may comprise an existing optical device and optical element 24 may be positioned adjacent refractive lens 26 within the existing optical device. In other cases, optical device 18A may comprise a new optical device and optical element 24 may be combined with refractive lens 26 to form the new optical device.

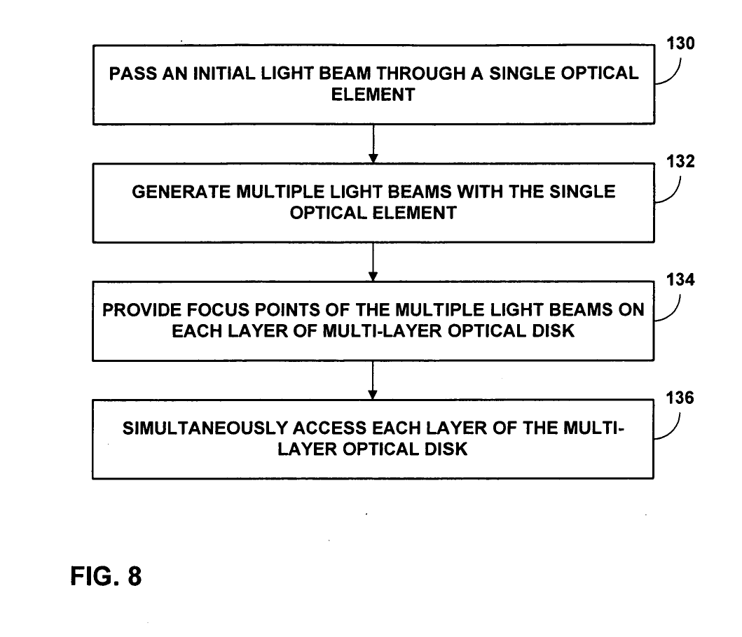

FIG. 8 is a flowchart illustrating an exemplary operation of simultaneously accessing multiple layers of a multi-layer optical data storage disk with a single optical element. The operation will be described in reference to optical device 18A and dual-layer optical disk 8A from FIG. 2. In other embodiments, the operation may be applied to optical device 74 and multi-layer optical disk 8C from FIG. 5. As described above, the techniques are described herein in reference to an optical device within a phase change initialization system. In other embodiments, the techniques may also be applied to a variety of other optical devices, such as read heads within disk drives.

Light source 22 included within optical device 18A generates an initial light beam and passes the initial light beam through single optical element 24 (130). Optical element 24 generates two light beams from the initial light beam (132). Refractive lens 26 then provides focus points 28 and 30 of the two light beams on each of the first layer 32 and second layer 36 of dual-layer optical disk 8A (134). In other words, refractive lens 26 provides a first focus point 28 of a first light beam from optical element 24 on first layer 32 and provides a second focus point 30 of a second light beam from optical element 24 on second layer 36. Once the focus points are provided on the layers, optical device 18A may simultaneously initialize the phase change recording material coated over first layer 32 and second layer 36 of dual-layer optical disk 8A for data recording (136).

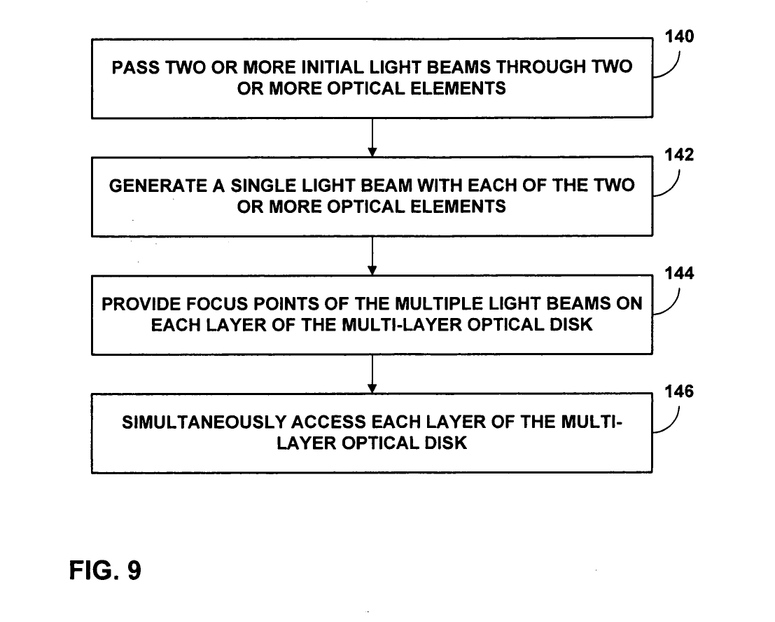

FIG. 9 is a flowchart illustrating an exemplary operation of simultaneously accessing multiple layers of a multi-layer optical data storage disk with multiple optical elements. The operation will be described in reference to optical device 18B and dual-layer optical disk 8B from FIG. 3. As described above, the techniques are described herein in reference to an optical device within a phase change initialization system. In other embodiments, the techniques may also be applied to a variety of other optical devices, such as read heads within disk drives.

Each of light sources 42A and 42B included within optical device 18B generates an initial light beam and passes the initial light beam through a respective one of optical elements 44A and 44B (140). Each of optical elements 44A and 44B generates a single light beam from the respective initial light beam (142). Refractive lens 46 then provides focus points 48 and 50 of the two light beams on each of the first layer 52 and second layer 56 of dual-layer optical disk 8B (144). In other words, refractive lens 46 provides a first focus point 48 of a first light beam from optical device 44A on first layer 52 and provides a second focus point 50 of a second light beam from optical device 44B on second layer 56. Once the focus points are provided on the layers, optical device 18B may simultaneously initialize the phase change recording material coated over first layer 52 and second layer 56 of dual-layer optical disk 8B for data recording (146).

Various embodiments of the invention have been described. For example, techniques have been described for simultaneously accessing multiple layers of an optical data storage medium using optical elements. In one embodiment, the techniques include passing light through a single optical element included in an optical device that generates multiple light beams, where each of the multiple light beams has a focus point on one of the layers of a multi-layer optical disk. In another embodiment, the techniques include passing light through two or more optical elements included in an optical device, where each of the optical elements generates a single light beam with a focus point on one of the layers of a multi-layer optical disk. In either embodiment, each of the multiple light beams has a focus point on one of the layers of a multi-layer optical disk to simultaneously access two or more of the layers of the optical disk.

For example, the optical device may be utilized within a phase change initialization system or as a read head within a disk drive. In the case of a phase change initialization system, the techniques described herein enable the optical device to simultaneously initialize phase change recording material applied over multiple layers included in a rewritable optical data storage disk for data recording. The optical device provides focus points of multiple light beams to simultaneously access the layers of the multi-layer optical disk and alter the phase change recording material on the layers. In the case of a read head, the techniques described herein enable the optical device to simultaneously readout data stored on each layer of a multi-layer optical data storage disk. The optical device provides focus points of multiple light beams to simultaneously access the layers of the multi-layer optical disk and the layers, in turn, simultaneously reflect the multiple light beams back to the read head for readout of the layers. In either case, the optical device sweeps over the optical disk only once while providing focus points of multiple light beams generated by at least one optical element on each layer of the optical disk.

Nevertheless various modifications can be made to the techniques described herein without departing from the spirit and scope of the invention. The techniques are primarily described herein with reference to optical devices within initialization systems. In addition, the optical disks are primarily depicted as including two or four layers with substantially uniform layer separation distances. However, the techniques may be applied to other optical devices, such as read heads within disk drives, to simultaneously readout data from a multi-layer optical disk. The techniques may also be applied to optical disks with any number of layers. Furthermore, the techniques may be applied to optical disks with non-uniform layer separation distances. These and other embodiments are within the scope of the following claims.

1. A method comprising:
generating multiple light beams by passing light through one or more optical elements; and
simultaneously accessing two or more layers of an optical data storage disk with the multiple light beams, wherein each of the multiple light beams has a focus point on one of the two or more layers of the optical data storage disk.

2. The method of claim 1, wherein generating multiple light beams comprises generating multiple light beams with intensity levels based on a power ratio for the layers of the optical data storage disk.

3. The method of claim 1, wherein generating multiple light beams comprises generating multiple light beams with focus points that are defined based on a separation distance between the layers of the optical data storage disk.

4. The method of claim 1, wherein generating multiple light beams comprises passing an initial light beam through a single optical element.

5. The method of claim 1, wherein generating multiple light beams comprises passing two or more initial light beams through two or more optical elements.

6. The method of claim 1, wherein simultaneously accessing the two or more layers of the optical data storage disk comprises simultaneously initializing phase change recording material applied over the two or more layers of the optical data storage disk for data recording.

7. The method of claim 1, wherein simultaneously accessing the two or more layers of the optical data storage disk comprises simultaneously reading data from the two or more layers of the optical data storage disk.

8. A system comprising:
an optical data storage disk including two or more layers; and
an optical device including one or more light sources and one or more optical elements, wherein the one or more light sources pass light through the one or more optical elements to generate multiple light beams, wherein each of the multiple light beams has a focus point on one of the two or more layers of the optical data storage disk to simultaneously access the two or more layers of the optical data storage disk.

9. The system of claim 8, wherein the one or more optical elements generate multiple light beams with intensity levels based on a power ratio for the layers of the optical data storage disk.

10. The system of claim 8, wherein the one or more optical elements generate multiple light beams with focus points that are defined based on a separation distance between the layers of the optical data storage disk.

11. The system of claim 8, wherein the optical device includes a single light source and a single optical element, wherein the single light source passes an initial light beam through the single optical element that generates multiple light beams.

12. The system of claim 8, wherein the optical device includes two or more light sources and two or more optical elements, wherein each of the two or more light sources passes an initial light beam through one of the two or more optical elements that generates a single light beam.

13. The system of claim 8, wherein the system comprises a phase change initialization system and the optical device simultaneously initializes phase change recording material applied over the two or more layers of the optical data storage disk for data recording.

14. The system of claim 8, wherein the system comprises a disk drive and the optical device comprises a read head that simultaneously reads data from the two or more layers of the optical data storage disk.

15. The system of claim 8, wherein the optical device includes a refractive lens positioned adjacent the one or more optical elements, wherein the refractive lens provides the focus point of each of the multiple light beams on the one of the two or more layers of the optical data storage disk.

16. The system of claim 8, wherein each of the one or more optical elements comprises a diffractive optical element including a surface relief pattern with one of a step grating or a blaze grating.

17. The system of claim 8, wherein each of the one or more optical elements comprises a holographic optical element.

18. A method comprising:
determining separation distances between two or more layers of an optical data storage disk;
determining power ratios for the two or more layer of the optical data storage disk; and
creating an optical element that generates one or more light beams from an initial light beam, wherein each of the one or more light beams has a focus point on one of the two or more layers of the optical data storage disk based on the layer separation distances and the power ratios.

19. The method of claim 18, wherein determining the separation distances comprises at least one of determining substantially uniform separation distances between two or more layers of a standard multi-layer optical data storage disk format and determining non-uniform separation distances between two or more layers of a multi-layer optical data storage disk format.

20. The method of claim 18, wherein determining the power ratio comprises determining an intensity level for each of the two or more layers of the optical data storage disk, wherein determining an intensity level for a lower layer of the optical data storage disk comprises determining an intensity level for the lower layer and for transmission through one or more upper layers of the optical data storage disk.
